(19) United States
(12) Patent Application Publication
(10) Pub. No.: US 2022/0205237 A1
(43) Pub. Date: Jun. 30, 2022

(54) Highly Efficient Energy-saving House

(71) Applicant: Weiguo Jiang, Shanghai (CN)

(72) Inventor: Weiguo Jiang, Shanghai (CN)

(21) Appl. No.: 17/606,020

(22) PCT Filed: Apr. 23, 2020
(86) PCT No.: PCT/CN2020/086255

§ 371 Date: Oct. 23, 2021

(30) Foreign Application Priority Data
Apr. 23, 2019 (CN) 201910326343.X

(51) Int. Cl. E04B 1/76; F16L 59/02; E04B 1/80

(52) U.S. Cl. CPC E04B 1/7641; E04B 1/80; F16L 59/028; F16L 59/029

(57) ABSTRACT

A highly insulated house, wherein on the basis of current technology of house insulation, a connecting structure with function of thermal-break bridge is set between the door and window's outer frame and the house's frame and external wall, and in the multiple-layered insulating structure of the house there is set a structure of wooden insulating bars or plastic insulating bars filled with insulating fiber, also there is set a fastener with function of thermal-break bridge, thus the overall insulation performance of the house is further boosted; wherein overlapping water boards are set between the multiple-layered insulating blocks of the external wall and roof, and water-proofing insulating blocks are set at the house frame, thus more convenient water-proofing is realized; wherein adhesive tape and insulating plate are set at the inner side of the insulating blocks of external wall and roof, so more convenient air-sealing is realized; wherein insulating structures of thin film with the multiple-layered connection, and with the block-connection by manual sticking or welding, with the automatic block-connection by direct molding, or by flat brim addition, by straight brim addition, by web-shaped addition—are used, thus for a house already built as well as a new house realization of high insulation is convenient and fast.

### FIELD OF TECHNOLOGY

This highly insulated house pertains to the field of construction.

### BACKGROUND TECHNOLOGY

Contemporarily, the conditions to realize high energy-saving for buildings are ready, but the technology to realize this while controlling the cost of its construction is not in wide use yet. For the efficiency of house energy-saving to be boosted for more than 90% while keeping the overall cost of construction unchanged or even lowered, a series of technologies are provided in the patent numbered 201610000457.1, wherein multiple layers of glass panel are assembled through bolts that enter the holes in the perimeter of the glass panel without using metal frame, and insulating bars are clamped by the brim of glass panel to form the multiple layers of cavity. This structure with multiple layers of cavity has no metal frame and its inner panels are ultrathin, so its weight is similar to that of double-layered glass curtain. But its cost is lower than glass curtain wall due to its cancel of all metal frame and keel, and its thermal insulation reaches the same level as brick wall that has been thickly clad by insulating fiber. Windows, doors, curtain walls and light skies using the above structure with multiple layers of cavity can be manufactured and used together with thickly insulated brick walls, roofs, and floors, so that the houses can be totally covered by the insulating structures to reach any level of thermal insulation desired in reality. At the same time, manufactured windows, doors, curtain walls and light skies using the above structure with multiple layers of cavity have not only a lower cost than traditional windows, doors, curtain walls and light skies, but also a longer service life. This series of techniques have been tested by experiments which formed the foundation for promotion. Besides glass, the above structure with multiple layers of cavity can also be manufactured with high polymer materials, etc. Furthermore, it may be replaced by insulating structures of thin film which can greatly reduce the cost.

In practical use, the various solutions provided in the above patent can solve all key problems. However, there is still space for improvement of the thermal insulating performance, installation methods, water-proofing, air-sealing, and insulating structures of thin film.

### CONTENT OF INVENTION

With the house publicized in the above patent which can reach any thermal insulating level desired in reality, when the insulating door and window of glass or other materials are installed onto traditional buildings, to eliminate the thermal bridge at the installing positions the conventional method of putting insulating fiber can be applied; alternatively the more efficient ways described below can be used. Also, when the insulating wall and roof of glass or other materials are installed, to realize water-proofing and air-sealing between their blocks, the methods provided in the above patent can do the job; alternatively the more convenient ways described below can be used. For the structure with multiple layers of cavity that is mentioned above, the manufacturing ways described below can further boost its thermal insulating performance. For the insulating structures of thin film said above, its manufacturing and installation can also be made more convenient through the ways below.

1) Ways to Eliminate Thermal Bridge at Installing positions when the Insulating Door and Window are Installed Onto Traditional Buildings

When the insulating door and window are installed onto traditional buildings, to realize high insulation, thermal-break bridge needs to be set between the door and window's outer frame and the external wall, so that when the door and window are closed, their insulating structure would be connected to the insulating layer of the external wall to form one body, and by virtue of this thermal break-bridge, the outer frame of door and window would not be affected by the ambient temperature.

When a new house of high insulation is being built, or when a brick house already built is being innovated for energy-saving, the connecting structure with thermal-break bridge function in the side view of FIG. 1 can be used: At the position of outer frame of door and/or window, the outer frame 1 and external wall 2 are connected by connecting rod 3 and connecting blocks 4, 5 which are made of wood or other materials of low heat conductivity; Connecting block 4 is firmly connected to the external wall through pre-embedded pieces, pre-installed pieces, after-embedded pieces, etc in the external wall/or the frame of house; Connecting block 4 can be firmly connected to connecting rod 3 through bolts; And connecting block 5 can be firmly connected to outer frame 1 of door and/or window through bolts.

In the above way of connection, an only route of heat conduction is formed between the external wall 2 and the outer frame 1 of door and/or window, which route of heat conduction is made of wood or other materials of low heat conductivity. The length of this route can be adjusted during the stage of design, so as to reach any needed thermal insulating level.

Besides being used for thermal-break bridge between external wall and outer frame of door and/or window, the above connecting structure with thermal-break bridge function can also be used for external wall of double wythes plus an insulating layer in between, as the thermal-break bridge between the inner wythe of light materials and floor or ceiling. See details in the later part of Concrete Implementation Methods.

2) Ways to Realize Water-Proofing and Air-Sealing Between Blocks of Insulating Wall and Roof

A) Ways to Realize Water-Proofing

The aforesaid insulating structure with multiple layers of cavity of glass or other materials assembled by bolts (for convenience, it shall be called “multiple-layered insulating block” hereunder) can be installed to positions of external wall and roof through pre-embedded or pre-installed connectors at the house frame, forming highly energy-saving curtain wall and skylight, and being able to be installed or taken down conveniently (see details in paragraphs 0152˜0163 in the Description of patent 201610000457.1. This patent shall be called the “original patent” hereunder). After these multiple-layered insulating blocks are installed to the house frame, for water-proofing and air-sealing between the neighboring blocks, besides the methods provided in the original patent, the following can also be used:

As shown in FIGS. 2,3,4,5,6,7,8, at the external wall and/or roof, multiple-layered insulating blocks 21,22 are set at the upper stratum, multiple-layered insulating blocks 23,24 are set at the lower stratum (see back view in FIG. 2). To prevent the rain from entering the house, at the left and right side of each block rain boards 35,36 shall be respectively set (see the enlarged view in FIG. 3), at the bottom of each block rain board 57 shall be set (see the enlarged side view in FIG. 5). When installing from inside the room, firstly install block 21, then install block 22 and let the rain board 35 of block 22 be pushed to the inner side of rain board 36 of block 21. Do in this way till the same stratum of blocks 21,22 are fully installed with blocks, the rain boards at the two sides of each block overlapping.

After the blocks of an upper stratum are installed, in the same way install blocks 23,24 of the lower stratum as well as all the rest of blocks in the same stratum, and letting the rain boards at the two sides of each block overlap. At the same time, the top of or the rain board at the top of block 23 shall be pushed to the inner side of rain board 57 at the bottom of block 21 (see side view in FIG. 5), and the top of or the rain board at the top of all the rest of blocks at the same stratum as block 23,24 shall be pushed to the inner side of rain boards at the bottom of the blocks at the upper stratum. Besides, rain boards 35,36 of the upper stratum shall respectively overlap rain boards 35,36 of the lower stratum, and the lower part of rain boards 36 of the upper stratum shall bend outward, so that it can cover the top of rain board 36 of the lower stratum; rain board 35 of the upper stratum shall not bend outward, but be aligned to rain board 35 of the lower stratum. By this means, whether the blocks are installed at the position of roof or external wall, water-proofing can be completely realized between the blocks. At where the blocks join the gable of the house, water-proofing can be done by setting covering boards at the top or side of the gable, which covering boards shall cover the blocks; At where the blocks join the house frame, water-proofing can be done by setting insulating blocks that have function of water-proofing, see details in the later part Concrete Implementation Methods.

B) Ways to Realize Air-Sealing

As shown in the top view of FIG. 4 and side view of FIG. 5, the rain boards of each block shall extend along the side to enter the inner side of the block to form flat plats 38; As shown in the top view 3 and side view of FIGS. 6,7,8, the side boards of each block shall also extend to enter the inner side of the block to form flat plates 38. Put adhesive tape to the neighboring plates 38, and a well air-sealing is done. Because there is a gap between neighboring blocks, to further boost thermal insulation (and also to improve aesthetical effects), fastener and insulating plate can be set at where the adhesive tape is put, the fastener fixing the insulating plate. This insulating plate can bring the double function of insulation and decoration.

The above ways to realize water-proofing and air-sealing between the blocks are much simplified than what is provided in the original patent (see paragraphs 0156, 0157, and 0159 of original patent), bringing a higher efficiency of installation and a lower cost.

3) Ways to Assemble the Structure with Multiple Layers of Cavity

For high insulation of houses, on the basis of what's described in the original patent (see paragraphs 0014˜0025 wherein), a structure of insulating fiber may be added to the sides of the structure with multiple layers of cavity, which can prevent heat conductivity at the sides; Thus its insulating performance can be further boosted. This side structure of insulating fiber may be made as follows:

A) Connected by Wooden Insulating Bars

If the insulating bars clamped in the structure with multiple layers of cavity is wooden, the side structure of insulating fiber may be made as shown in FIG. 9: In one of the cavities of the structure 91 with multiple layers of cavities, wooden horizontal insulating bar 92 and vertical insulating bar 93 are connected at the perimeter of the cavity at the position of bolt hole 94 where they may overlap; The bolt can enter both wooden insulating bars 92 and 93. The overall thickness of the position where wooden insulating bars 92 and 93 overlap shall equal thickness of the cavity. At where the wooden insulating bars do not overlap, each wooden insulating bar shall have the same thickness as the cavity. In wooden insulating bars 92,93 there are set connectors 95 (connector 95 may be set as an indentation having an opening narrower than inside); Connectors 95 join the connectors of insulating bars 96 of plastic or other low-heat-conductivity materials. In insulating bars 96 there can be set connectors 97 (connector 97 may also be set as an indentation having an opening narrower than inside) so that they can be connected to each other. Connect multiple insulating bars 96 of plastic or other low-heat-conductivity materials to the wooden insulating bars 92,93, and successive small boxes 98 will be formed. Fill the small boxes 98 with insulating fiber, and heat conductivity between sides of the multiple layers of cavity and the outside can be minimized.

B) Connected by Insulating Bars of Plastic or Other Low-Heat-Conductivity Materials

If the insulating bars clamped in the structure with multiple layers of cavity is not wood but plastic or other materials of low-heat-conductivity, the side structure of insulating fiber may be made as shown in FIG. 10: In one of the cavities of the structure 101 with multiple layers of cavities, insulating bars 102 form successive horizontal boxes, insulating bars 103 form successive vertical boxes. In the perimeter of the cavity at the position of bolt hole 104 the horizontal boxes and vertical boxes may be connected by overlapping. At the same time, at the position of bolt hole 104 the horizontal box of insulating bar 102 and the vertical box of insulating bar 103 shall have a ring with spokes connecting the ring to the horizontal or vertical box. The overall thickness of the position where the horizontal box of insulating bars 102 and the vertical box of insulating bars 103 overlap shall equal thickness of the cavity. At where the insulating bars do not overlap, each insulating bar shall have the same thickness as the cavity. If a bolt hole needs to be added at where the horizontal boxes and vertical boxes do not overlap, a ring with spokes shall be set for connection of the bolt. The horizontal and vertical boxes shall be filled with insulating fiber 105, so that the heat conductivity between sides of the multiple layers of cavity and the outside can be minimized.

4) Ways for Manufacture and Installation of Insulating Structures of Thin Film

When the panels in the above structure with multiple layers of cavity are replaced by thin films, on the condition of keeping its insulating performance its weight can be greatly reduced and a lot of materials can be saved, which can greatly popularize the use of highly insulating houses. To ensure the thermal insulating performance of this structure of thin film, its shape, volume, position, and structures must be kept stable when it is put to use. For this, methods provided in paragraphs 0168˜0180 of the Description of the original patent can be applied. Also, one or more of the following multiple-layered connection, block-connection by manual sticking or welding, block-connection by direct molding, block-connection by flat brim addition, block-connection by straight brim addition, block-connection by web-shaped addition, etc—can be applied, which are more convenient.

A) Multiple-Layered Connection

As shown in the front view of FIG. 11, threaded rod 111 is installed in the inner side of external wall and/or in the bottom of ceiling; Cross-shaped connector 112 has a circular hole 113 at its center, and has connectors 114 at its four terminals for connection of thin film separating straps; Connectors 114 have snaps etc. to fasten the separating straps of thin film; Connectors 114's snap has a protuberance with an arrow-shaped section which can be pressed into the corresponding groove; Between the protuberance of Connectors 114's snap and it groove there is some space, so that when the thin film is added the protuberance can still be pressed into the groove and fix the thin film. The thickness of connectors 114 is the same as connector 112. In circular hole 113 there is set disk 115 that is made of insulating materials such as polystyrene, and that has a hole in the center to match threaded rod 111 and let threaded rod 111 enter the hole. After multiple threaded rods 111 have been installed in the inner side of external wall and/or in the bottom of ceiling, make holes in the first layer of large thin films in the positions of threaded rods 111. Then put these thin films onto the threaded rods 111, and press disks 115 onto threaded rods 111. Then stick the neighboring large thin films together with adhesive tape. Next, put the circular hole 113 of connectors 112 onto disks 115. Then use the connectors 114 to connect the thin film separating straps between every two neighboring threaded rods 111, which thin film separating straps shall have the same thickness as connector 112. This insulating structure of thin film shall have multiple layers. After every two neighboring threaded rods 111 in the first layer have been connected by the thin film separating straps, install the large thin films, disks, cross-shaped connectors, thin film separating straps of the second layer in the same way as in the first layer. Continue in this manner till all the layers are installed. Then on the top layer put gaskets of plastic or other low-heat-conductivity materials onto the end of threaded rods 111; The diameter of these gaskets shall be greater than circular hole 113. Then install nuts onto the threaded rods 111, and put thick insulating caps onto the nuts.

B) Block-Connection

a) Method of Direct Molding

As shown in the side view of FIG. 12, multiple-layered structure 121 of thin film is directly molded by melted plastic through extrusion-molding. This multiple-layered structure 121 has the top layer 122, bottom layer 123, and middle layers 126,127,128, etc. After the molding, cut the multiple-layered structure 121 to sections and weld their edges along the cutting line. Next make a hole on the top layer 122 by puncturing etc; This hole shall penetrate the middle layers 126,127,128, etc. but shall not penetrate the bottom layer 123. At the same time set a sealable air-inflating hole on top layer 122 at where the punctured hole is; The air-inflating hole may have an air pipe and a sealing plug, the root of the air pipe connected to the top layer 122. When a section of the multiple-layered structure is inflated and sealed, it becomes like a box, its sides 124,125 being flat; But its other two sides where the welding has been done look like a triangle if viewed sideways. When these multiple-layered structures are installed onto the house, each row or each column of them shall have the uniform direction, so that the flat sides 124,125 will be consecutive, and the triangle-shaped sides will overlap.

The above method of direct molding can realize semi-automatic or automatic production, greatly saving labor and cost.

b) Methods of Sticking or Welding

\textcircled{1} Manual Production: Cut a long cylinder-shaped thin film to sections, or weld a shorter thin film to a cylinder shape; Then use a support to stretch a section of cylinder-shaped thin film to be a frame 131 as shown in the side view of FIG. 13. Inside frame 131 the two sides 1321,1322 of multiple thin films 132 which have the same width as this frame shall be respectively welded or glued to the two sides 133,134 of frame 131; This welding or gluing does not need to be continuous; As long as thin film 132's end points and a number of middle points are connected to the sides of frame 131, it will be alright. In the longitudinal direction, frame 131 shall be longer than thin film 132. After the above welding or gluing is completed, remove the support; Then respectively add two other thin films at the two empty sides of frame 131; And at the brim where this frame is longer than thin film 132 weld continuously without leaving a gap (it can also be done by gluing, which is not as environment-friendly), so that frame 131 becomes a multiple-layered structure of thin film with its six sides sealed. At its surface layer there shall be made a hole by puncturing etc, and a sealable air-inflating hole shall be set at where the punctured hole is. When stored or transported this multiple-layered structure of thin film shall be deflated so as to save space. When being used, it shall be inflated and sealed.

\textcircled{2} Flat Brim Addition: In the process of thin film production, use blow molding and mould to make the thin film into a box 141 as shown in the section of FIG. 14; Box 141 has convex brims 142 at its top and bottom, and an air-pipe 143 at its side. Make box 144 in the same way; Box 144 has convex brims 145 at its top and bottom, and an air-pipe 146 at its side. Then, inflate boxes 141,144 and put them one above another; Then press two neighboring convex brims 142,145 together, and keep a part of the these convex brims outside of the pressing line; Then at the part outside of the pressing line weld convex brims 142,145 together. When they cool down, release the pressing line and the two thin film boxes 141,144 are joined to be one body. Continue in this manner and multiple boxes of thin film can be welded together to form an insulating multiple-layered structure of thin film with any number of cavity layer needed in reality. After this multiple-layered structure of thin film is formed, all its air-pipes can be joined to a general air-pipe so that inflation, sealing, and deflation can be done simultaneously. When stored or transported this multiple-layered structure of thin film shall be deflated so as to save space. When being used, it shall be inflated and sealed.

The above method of flat brim addition can realize semi-automatic or automatic production, greatly saving labor and cost.

\textcircled{3} Straight Brim Addition: In the process of thin film production, use suck-molding and mould to make the thin film into a semi-box 151 as shown in the side view of FIG. 15; Semi-box 151 has convex brims 152 and opposite sides 153. At the same time, use suck molding and another same mould to make the thin film into a semi-box 154 which has convex brims 155 and opposite sides 156. When semi-boxes 151,154 are still hot and sticking, press their sides 153,156 together (see the side vide of FIG. 16); They will be welded together after cooling down, and a sealed box 167 will be formed which is full of air inside and has convex brims 152,155 respectively at its top and bottom. In the same way make sealed box 168 which has the convex brims 169 at its top and bottom. Then put sealed boxes 167,168 one above another; Then press two neighboring convex brims 155,169 together, and keep a part of the these convex brims outside of the pressing line; Then at the part outside of the pressing line weld convex brims 155,169 together. When they cool down, release the pressing line and the two sealed boxes 167,168 are joined to be one body. Continue in this manner and multiple sealed boxes can be welded together to form an insulating multiple-layered structure of thin film with any number of cavity layer needed in reality. After this multiple-layered structure of thin film is formed, at its top layer there shall be made a hole by puncturing etc, which hole shall penetrate all layers except the bottom layer; And a sealable air-inflating hole shall be set on the top layer at where the punctured hole is. When stored or transported this multiple-layered structure of thin film shall be deflated so as to save space. When being used, it shall be inflated and sealed.

The above method of straight brim addition can realize semi-automatic or automatic production, greatly saving labor and cost.

\textcircled{4} Web-shaped Addition: As shown in the section of FIG. 17, any number of thin film layers needed in reality—layers 171,172,173,174, etc. are welded or glued together along the crosswise connection lines 1711,1712,1713,1714, etc. and 1721,1722,1723,1724, etc. On each layer of thin film in the direction perpendicular to the connection lines leave a side 175 (see the top view in FIG. 18). After all welding or gluing along the above connection lines is completed, weld or glue sides 175 together along their outer brim, and let this welding line or gluing line join the outer-most connection lines 1711,1721, etc, so that sealing will be done. After completion of the above tasks, make a hole by puncturing etc. at the top layer, which hole shall penetrate all layers except the bottom layer; And a sealable air-inflating hole shall be set on the top layer at where the punctured hole is. When inflation is done, the multiple thin film layers 171, 172, 173, 174, etc will be separated by air.

In the above multiple-layered structure of thin film, sides 175 of every layer are connected such that when inflation is done the two sides of the whole structure have a section that roughly looks like a triangle; At where two multiple-layered structures join, the position of the triangle-shaped sides will not be flat. This structure can be called Structure With Triangle Sides. If under some circumstances the sides need to be flat, the above multiple thin film layers 171,172,173,174 etc. can have double films except the top layer and bottom layer; Each layer with double films shall be welded along an extra connection line which connects the ends of the connection lines 1711,1712,1713,1714, etc. When the welding or gluing of all layers of thin film along the connection lines 1711,1712,1713,1714, etc is completed, join every couple of up-and-down sides 175 (i.e. sides 175 of layer 171,172 shall be a couple, sides 175 of layer 172,173 shall be a couple, sides 175 of layer 173,174 shall be a couple, and so on) by welding or gluing. By this means, it can be avoided to join all sides 175 together through one connection line, and a relatively flat side can be realized. This structure can be called Structure With Flat Sides.

If a cylinder-shaped thin film made by blow molding is directly used, it can be pressed flat to have double layers. When these double-layered thin films are welded along the crosswise connection lines 1711,1712,1713,1714, etc, the two crosswise connection lines at the ends of each layer shall be extended to be as long as the width of the thin film, so that these thin films will be sealed, and sides 175 no longer need to be welded. This structure can be called Structure With Cylinder-shaped Thin Film. Because its up-and-down sides 175 need not to be welded, when inflation is done, there will be multiple unsealed cavities across the structure, which will bring some negative effects to its thermal insulation.

The Web-shaped Addition can have one or more or the above three structures: Structure With Triangle Sides, Structure With Flat Sides, and Structure With Cylinder-shaped Thin Film.

C) All the Insulating structures of thin film with the above Multiple-layered Connection or Block-connection can be used for thermal insulation of various types of buildings including energy-saving houses. The thickness and number of layers in these insulating structures can be freely set to meet any thermal insulating level needed in reality. On at least one of its layers there shall be set reflective material.

### BRIEF DESCRIPTION OF DRAWINGS

FIG. 1 is thermal-break bridge of door and/or window's outer frame.

FIGS. 2,3,4,5,6,7,8 are ways to realize water-proofing and air-sealing between multiple-layered insulating blocks.

FIG. 9 is wooden insulating bars in a structure with multiple layers of cavity.

FIG. 10 is insulating bars of plastic or other low-heat-conductivity materials in a structure with multiple layers of cavity.

FIG. 11 is multiple-layered connection for insulating structure of thin film.

FIG. 12 is direct molding for block connection of insulating structure of thin film.

FIG. 13 is manual sticking or welding for block connection of insulating structure of thin film.

FIG. 14 is sticking or welding with flat brim addition for block connection of insulating structure of thin film.

FIGS. 15,16 are sticking or welding with straight brim addition for block connection of insulating structure of thin film.

FIGS. 17,18 are sticking or welding with web-shaped addition for block connection of insulating structure of thin film.

FIGS. 19,20,21,22 are installation of insulating plate.

FIG. 23 is installation of horizontal insulating block.

FIGS. 24,25 are installation and water-proofing of vertical insulating block.

FIG. 26 is water cover for connecting bar of horizontal insulating block.

FIG. 27 is water-proofing for horizontal insulating block.

FIG. 28 is water cover for connecting rod of multiple-layered block of external wall.

FIG. 29 is another method of water-proofing for horizontal insulating block.

FIGS. 30,31 are rain plates on multiple-layered block of external wall.

FIGS. 32,33,34 are methods of water-proofing for protruding column on roof.

FIGS. 35,36,37 are support with thermal-break bridge in multiple-layered insulating block.

### CONCRETE IMPLEMENTATION METHODS

1) Implementation of Thermal-Break Bridge for Door and/or Window, as well as for Double-Wythed Wall

A) In the highly insulated house, through the multiple-layered structure that has eliminated the thermal bridge, the door and/or window themselves can reach any insulating level needed in reality. When this door and/or window are connected to the external wall, at the outer frame of the door and/or window if a thermal-break bridge is not set, then an insulating layer needs to be added as a cover. If a high insulating level of the whole house is required, this added insulating layer must be set very thick and wide, which will not only increase the cost of building, but will affect the visual effect and impede the opening and closing of the door and/or window. When the thermal-break bridge described before (in part 1 of Content Of Invention) is used, then the added insulating layer can be canceled.

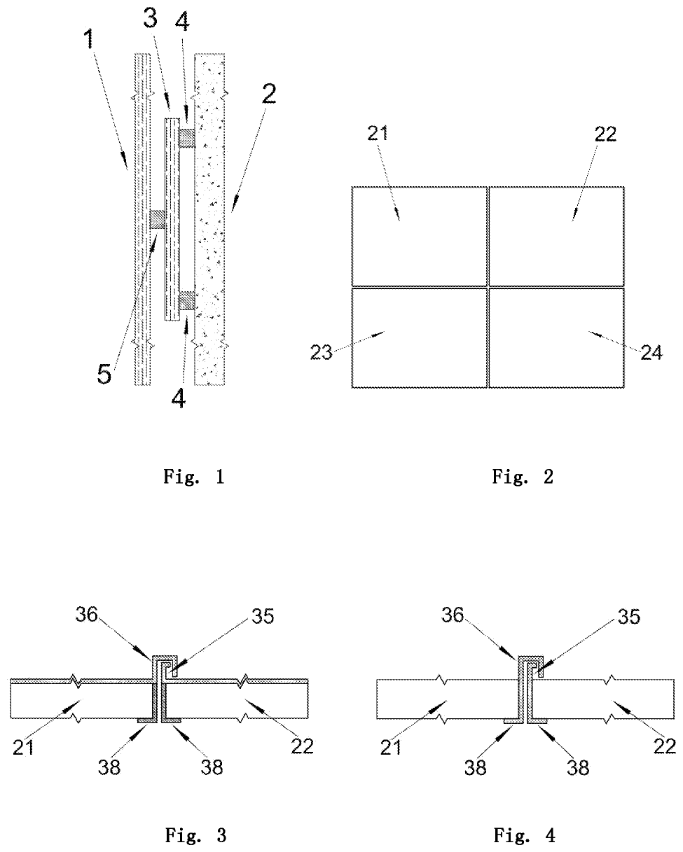

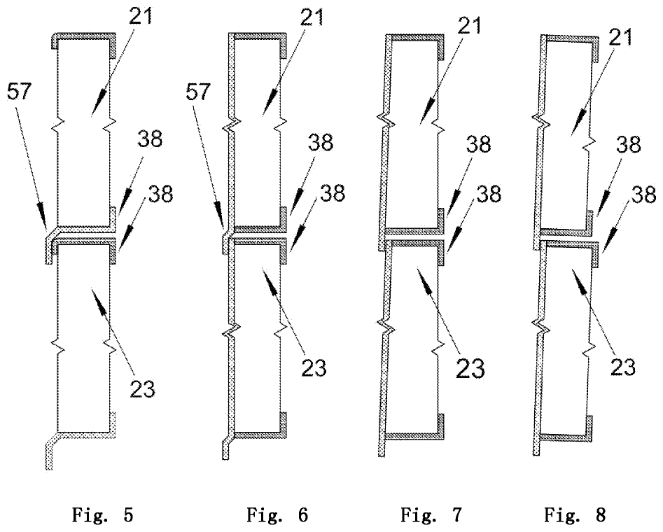

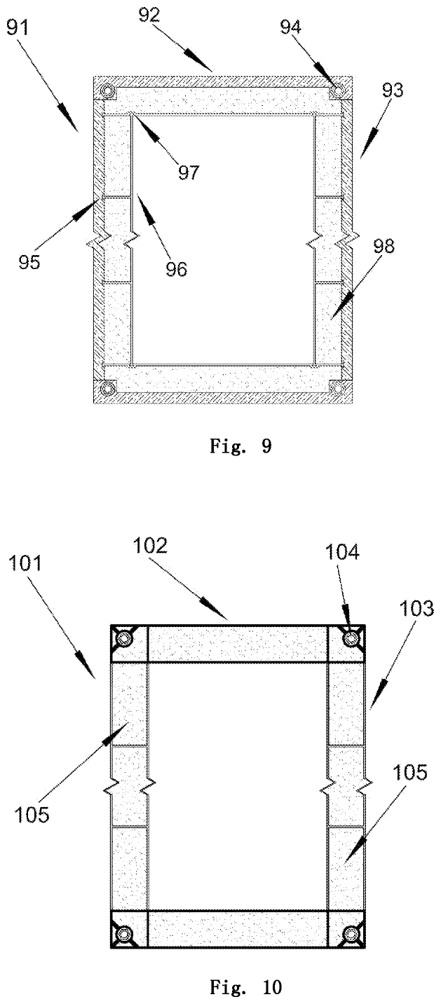

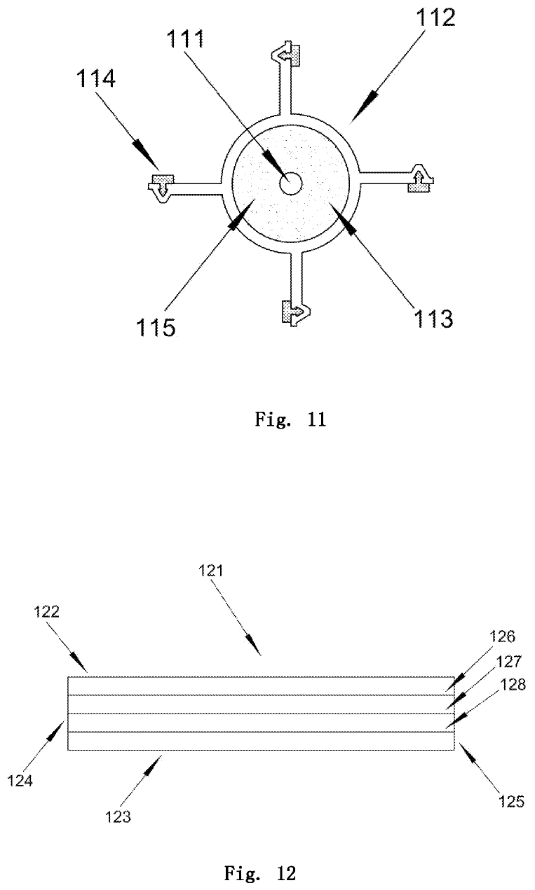

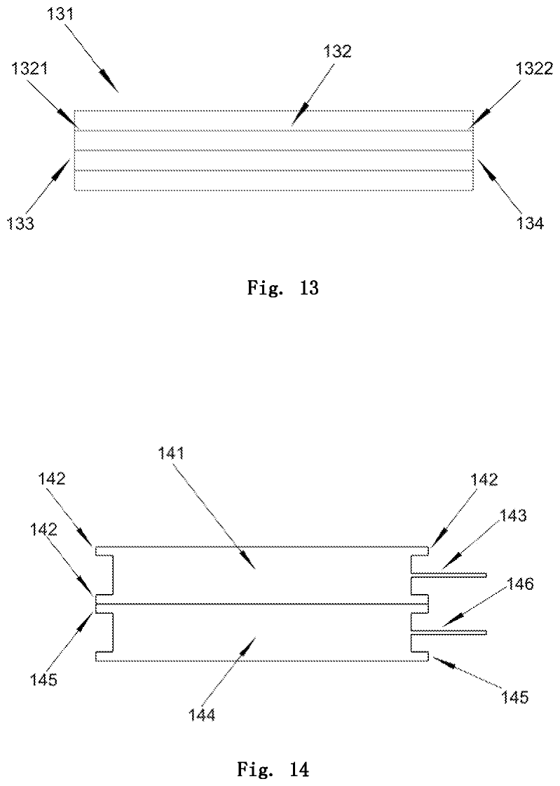

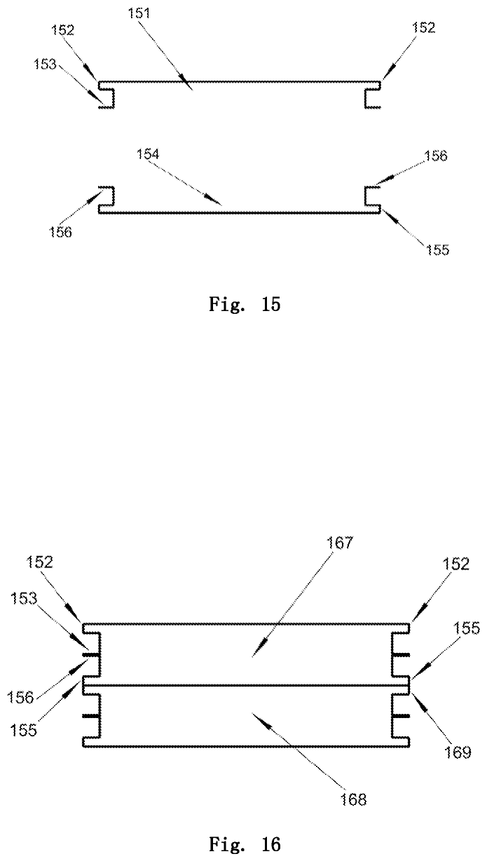

When this bridge is installed at the outer frame of the highly insulating door and/or window, in FIG. 1 the connecting rod 3 and connecting blocks 4,5 shall be set between the outer frame and the external wall in the direction perpendicular to the panel of door and/or window (this outer frame shall be set inside of the external wall), and shall be set around the opening for door and/or window in the external wall. At the same time, at the two sides of connecting rod 3 and connecting blocks 4,5 and in the space between them there shall be set insulating fiber, which insulating fiber shall be connected to that on the inner side of the external wall without leaving a gap. This installation of insulating fiber is not the same as installation of fiber at the other side of the outer frame of door and/or window: The former is done between the outer frame and external wall for connection of the door and/or window's insulating structure to the insulating fiber on the inner side of external wall; The latter is for cover of the outer frame because there is no thermal-break bridge between the outer frame and external wall, thus this cover must be wider than the outer frame for connection of the door and/or window's insulating structure to the insulating fiber on the inner side of external wall, which will impede the door and/or window's opening and closing.

But through the method of setting the thermal-break bridge as described above, it can be avoided to impede the door and/or window's opening and closing, and the insulation of door and/or window can be seamlessly connected to the insulation of fiber on the inner side of external wall, thus letting insulation of door and/or window combined to that of external wall, roof (or ceiling), and floor to reach any level of thermal insulation needed in reality.

For curtain wall of glass (or other materials) that has the insulating structure with multiple layers of cavity, the way to install the door and/or window is basically the same (the highly insulating glass curtain wall can be regarded as a brick wall clad with a thick insulating layer): The thermal-break bridge described above shall be installed at the outer frame of door and/or window (usually for a curtain wall on steel-framed house or concrete-framed house there shall be set corresponding structural frame at the position of door and/or window, so that the outer frame of door and/or wind can be installed onto the structural frame), and the insulating fiber at the thermal-break bridge of the door and/or window's outer frame shall be pressed onto the glass curtain wall, so that seamless connection of the insulation of door and/or window to that of the external wall can be done.

B) When the external wall has double wythes with insulating fiber put in between, the overall insulation of the house can be greatly improved. However, when more than 90% of the energy for heating or cooling needs to be saved, if the outer wythe and inner wythe are connected by bolts (see patent 201510155539.9), the material of bolts shall be replaced by wooden or other low-heat-conductivity materials; If the double wythes are connected by steel bars (see the same patent), the steel of bars shall also be replaced by wood or other low-heat-conductivity materials. By this means, it can be avoided to let the metal connectors become the thermal bridge between the outer and inner wythes. At the same time, at where the outer wythe connects the frame of house at the floor and ceiling, a thermal bridge is still formed between the outer wythe and inner wythe. To offset the negative effect of this thermal bridge, one method is to set a thick insulating layer at the position of inner wythe, floor, and ceiling; This thick insulating layer needs to be set very wide and thick, which increases the cost. Another method is to set the outer wythe as the main wall, to use thin light concrete for the inner wythe, and to apply the same thermal-break bridge of door and/or window as describe above to where the inner wythe connects the floor and ceiling. There is one difference between the thermal-break bridge used at the inner wyther and that used at the door and/or window: The thermal bridge at the inner wythe is set at the top and bottom of it, being in the same plane as the inner wythe; But the thermal-break bridge of the door and/or window is set at the side of their outer frame, being perpendicular to the panel of door and/or window.

The external wall of double wythe with insulating fiber put in between can be used for permanent insulation. But its cost is high, and it is usually suitable for luxurious buildings. If insulating structures with multiple layers of cavity made of high polymer materials are set on the inner side of a single-wythed external wall, the same level of thermal insulation can be reached, more visual effects can be realized, and the cost can be greatly reduced. But these structures need to be replaced after a number of years (i.e. When their materials are aged, they shall be replaced. With high-quality materials, the service time can be about 20 years).

2) Implementation of Water-Proofing and Air-Sealing Between Blocks of Insulating Wall and Roof

A) The multiple-layered insulating blocks with rain boards described before (in part 2A of Content Of Invention) can be installed from inside the room or outside the room. Whether to do it from inside or outside shall depend on the direction of the connecting rods set between the house frame and the multiple-layered insulating blocks: If the connecting rods direct to inside the room, install from inside; If they direct to outside the room, install from outside. For most buildings, especially high-rise buildings, installation from inside the room is suitable. For low buildings, especially single-stored ones, installation from inside or outside may both be suitable. When installation is done from outside the room, the order to install the insulating blocks is opposite to that for installation from inside. The fixing of the insulating blocks and water-proofing at the position of bolts can be done by the out-directing bolts, height-adjusting devices, and sealant at position of the bolts (see paragraphs 0118˜0121 in Description of the original patent). Water-proofing at the position of bolts can also be done by setting water covers on the insulating blocks above the bolts: The bolts are set at the bottom of the insulating block above them; On the insulating blocks above the bolts there shall be set rain covers through direct molding, melting-connection, bending, etc; The water covers cab be extended to outside the insulating blocks below the bolts, because during installation from outside the room the lower row of insulating blocks are installed before those of the upper row; The rain covers shall have enough space around the bolts, so as not to impede installation of the bolts' gaskets, nuts, and insulating caps.

The rain boards 35,36 at the two sides of the multiple-layered insulating block may be integrated to the outer layer of the insulating block to form one body (through direct molding, bending, etc), as shown in FIG. 3; They may also be separately installed to the sides of the insulating block, as shown in FIG. 4. The method of integration is good for water-proofing, but it will increase the cost to an extent; The method of separate installation can simplify the manufacturing, but strict sealing must be done at where the rain board is connected to the outer layer of the insulating block.

The rain board 57 at the bottom of very block may be separately installed as shown in FIG. 5; It may also be an extension of the outer layer of the insulating block as shown in FIGS. 6,7,8. The method of separate installation can simplify the manufacturing, but strict sealing must be done at where the rain board is connected to the outer layer of the insulating block. The method of extension is good for water-proofing, but in FIG. 6 the lower part of the outer layer needs to be directly molded, or bent, etc. to form the rain board 57 that is bent outward so as to let the upper and lower insulating blocks overlap, which will increase the cost to an extent; In FIG. 7 the lower part of each block needs to be set wider than the upper part, so as to let the upper and lower insulating blocks overlap; In FIG. 8 each block needs to be slanted in installation, so that the upper and lower insulating blocks can overlap.

At where the rain boards 35,36 at the two sides of an insulating block connect the rain board 57 at its bottom, the rain boards may be integrated as one body or be separated. If they are integrated, during installation the rain boards 35,36 at the two side of the upper insulating blocks shall overlap those of the lower insulating blocks, and the neighboring left-and-right rain boards 57 at the same level shall not overlap. If the rain boards are separated, the rain running off rain boards 35,36 shall fall onto rain boards 57 at the bottom; In this case, during installation the neighboring left-and-right rains boards 57 at the same level shall overlap, and the rain boards 35,36 of the upper blocks shall no longer overlap those of the lower blocks.

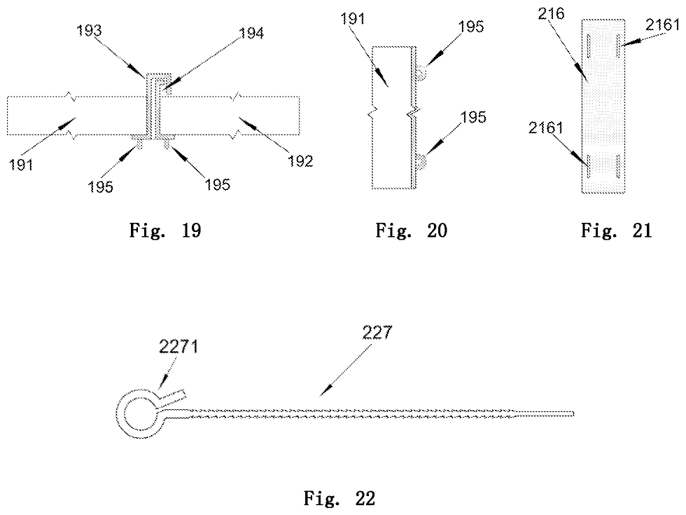

B) The fastener and insulating plate described before (in part 2B of Content Of Invention) may be set as per FIGS. 19,20,21,22: At the external wall and/or roof, the left multiple-layered insulating block 191 and the right multiple-layered insulating block 192 respectively have rain board 193,194; On the inner side of both blocks 191,192 there are set connectors 195 (which may be connecting rings. see the top view in FIG. 19, and the side view in FIG. 20) near the boundary of the two blocks; In insulating plate 216 there are set slots 2161 (see the back view in FIG. 21). Spinous strip 227 (see the section in FIG. 22, in which it is enlarged) has connector 2271 (which may be set in a U-shape) at its end. Connector 2271 can be connected to connector 195 so that spinous strip 227 is connected to multiple-layered insulating blocks 191,192. Spinous strip 227 can enter slot 2161. Slot 2161 can lock spinous strip 227 (The slot may be set narrower at its outer side than its inner side, so that its narrower part can lock the spinous strip), making it movable only to the outer direction so as to fasten insulating plate 216, making this plate pressed to where the left and right multiple-layered insulating blocks join each other. When connector 2271 is put onto connector 195, it can turn; Thus even if slot 2161 is not aligned to connector 195, spinous strip 227 can be turned to slot 2161 and pass through it. Slot 2161 may be set long, so as to give allowance to the position of connector 195 within a range. The width of spinous strip 227 may be increased to make it stronger. Spinous strip 227 may be separately set as above; It may also be set as an integrated part of the multiple-layered insulating block or the components on it.

After multiple-layered insulating blocks 191,192 are installed, inside the room put adhesive tape to the inner side of these blocks at the boundary of them. Thus their air-sealing is done. Next, put the connector 2271 of spinous strip 227 onto connector 195. Then put insulating plate 216 to near the boundary of the insulating blocks, and let spinous strips 227 pass through the slots 2161 that are near the two sides of insulating plate 216. Then pull spinous strips 227 to make insulating plate 216 pressed to the boundary of the two insulating blocks, which will further boost their insulating performance. Every insulating plate 216 shall have at least 4 slots 2161 at its perimeter; And every slot 2161 shall be connected to the insulating block through spinous strip. Where two insulating plates join, they may have rabbets to be aligned. If an insulating plate is long, besides the 4 slots at the perimeter, it must have more slots for spinous strip set at intervals. In addition, the insulating plates must be made of light material to ensure safety.

C) Installation of Insulating Blocks at the House Frame

When installing the insulating blocks described in the original patent (see paragraph 0115 in its Description), the mounting components and the insulating block may be as follows:

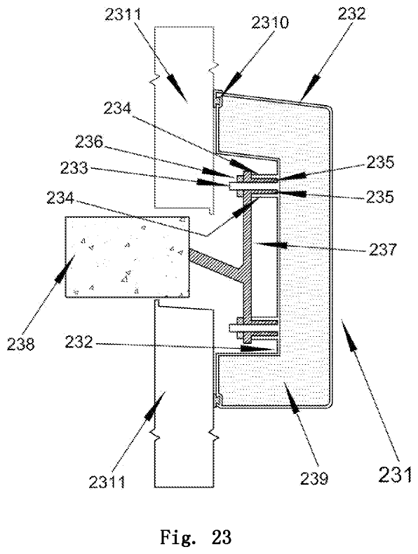

As shown in the side view of FIG. 23, shell 232 of horizontal insulating block 231 has a thickness such that connecting bar 233 and connecting cylinder 234 can be connected on shell 232 through direct molding, melting-connection, etc. The connecting bar 233 and connecting cylinder 234 may also be set at other suitable positions of the insulating block 231. Connecting cylinder 234 is set around connecting bar 233. During installation, the insulating block 231's connecting bar 233 is inserted into the connecting cylinder 235 of the house frame's connecting rod 237; at the same time, connecting cylinder 235 of the house frame's connecting rod 237 is inserted into connecting cylinder 234 of the insulating block. Connecting bar 233 of the insulating block passes through connecting cylinder 235 of the house frame's connecting rod 237, and has screw thread and bolt nut 236 at its end (It may alternatively has a pin or other stopping piece). Thus the insulating block's connecting bar 233 and connecting cylinder 234 are fixed to the connecting cylinder 235 of the house frame's connecting rod 237. The house frame's connecting rod 237 is connected to the horizontal part 238 of the house frame; The house frame may be reinforced concrete or steel structure etc; The root of connecting rod 237 (i.e. its part connecting the horizontal part 238 of the house frame) may be set to direct downward or to have a rain board, so the rain can be prevented from flowing to the house frame. The shell 232 of insulating block 231 may be made of two parts with insulating fiber 239 filled in the cavity formed by them.

At the brim of insulating block 231 there may be set a groove in which elastic rubber bar 2310 is put, so that after the external wall's block 2311 is installed, the brim of insulating block 231 can touch the external wall's block 2311 without leaving a gap, and the overall insulating performance will be improved.

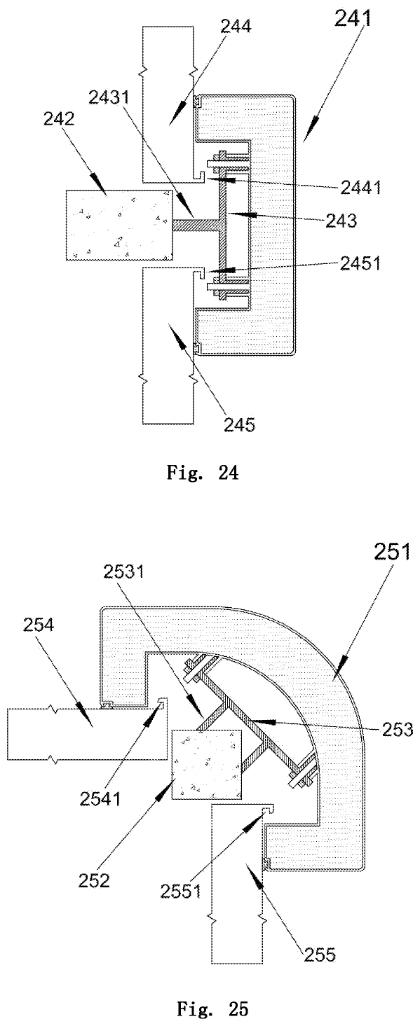

Installation of vertical insulating block is similar to that of horizontal insulating block. Except for the position at the corner of house, the installation of vertical insulating block may be as per the top view in FIG. 24: Vertical insulating block 241 is mounted to the vertical part 242 of the house frame; The root 2431 of its connecting bar 243 may be set to direct downward or to have a rain board. The method to connect the vertical insulating block 241 to the house frame's connecting rod 243 is the same as what's described above about connection of the horizontal insulating block 231 and the house frame's connecting rod 237: On vertical insulating block 241 there are set connecting cylinder and connecting bar; On the house frame's connecting rod 243 there is set connecting cylinder; These connecting cylinders are inserted or pushed to each other; And the vertical insulating block's connecting bar passes through the house frame's connecting cylinder, having screw thread and bolt nut at its end or alternatively having a pin or other stopping piece.

At position of the corner of house, the vertical part of house frame also needs to be covered by insulating blocks. Their installation may be as per the top view in FIG. 25: Vertical insulating block 251 is connected to the vertical part 252 of the house frame at the position of house corner. If the angle of house corner is 90 degrees, the connecting cylinder of the house frame's connecting rod 253 shall have an angle of 45 degrees to the wall of house, and insulating block 251's connecting bar and connecting cylinder shall also have an angle of 45 degrees to the wall, so that these connecting bar and connecting cylinders are in the same direction; If the angle of house corner is not 90 degrees, direction of the connecting cylinder of the house frame's connecting rod 253, and of insulating block 251's connecting bar and connecting cylinder shall be adjusted accordingly, so that they are kept in the same direction. Then, when insulating block 251 is pushed, its connecting bar can be pushed into the connecting cylinder of the house frame's connecting rod 253, which connecting bar has screw thread and bolt nut at its end or alternatively has a pin or other stopping piece; at the same time, the connecting cylinder of house frame's connecting rod 253 is inserted to the insulating block 251's connecting cylinder. Thus insulating block 251 is firmly fixed to connecting rod 253. The root 2531 of connecting bar 253 may be set to direct downward or to have a rain board.

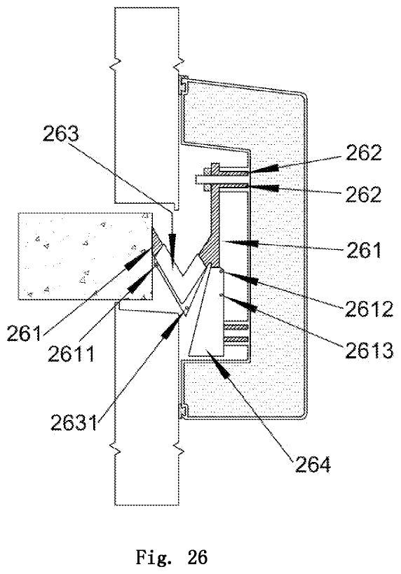

As shown in FIG. 23, the rain can flow into the inner side of horizontal insulating block 231. If the connecting rod 237 and connecting cylinder 235 have no rain cover, they must be made of stainless steel, aluminum alloy, etc. which will not easily rust or corrode; And they must be periodically inspected. If the connecting rod 237 and connecting cylinder 235 have rain covers, they may be set as per the side view in FIG. 26: The root of connecting rod 261 (i.e. its part connecting the horizontal part of the house frame) is set to direct downward then upward, or to have a rain board, so that the rain cannot flow to the root of connecting rod 261, nor to the upper connecting cylinder 262; At the root of connecting rod 261 there is set hole 2611; Rain cover 263 may be made of plastic materials, and covers a lower part of connecting rod 261, having holes at its upper part at the two sides of hole 2611; The lower part of rain cover 263 surpasses the bottom of the bending part of connecting rod 261, and has holes 2631 at its two sides at the level lower than the bottom of the bending part of connecting rod 261 (In the figure, for the purpose of showing the connecting rod 261, the area of rain cover 263 is reduced. In actual use rain cover 263 shall extend upward so as to prevent the rain from splashing to connecting rod 261; At the same time connecting rod 261 may have connecting holes set at its upper part to fix rain cover 263). During installation, put rain cover 263 onto connecting rod 261 and use binding strip through holes 2611,2631 to fix this rain cover. On the other hand, at the lower part of connecting rod 261 and the lower connecting cylinder there shall be set rain cover 264 which may be made of plastic materials and can prevent the rain for plashing to the lower part of connecting rod 261 and to the lower connecting cylinder. Rain cover 264 can be fixed by binding strip through the hole 2612 at the middle part of connecting rod 261 and through the corresponding holes in rain cover 264 at the two sides.

Alternatively, the upper rain cover 263 and the lower rain cover 264 may be fixed to the connecting rod 261 through buckling, and/or sticking, welding, embedding, riveting, bolting, etc.; At the same time, the upper rain cover 263 and lower rain cover 264 may be integrated as one body.

The rain cannot flow into the inner part of vertical insulating blocks (see the last two paragraphs in part D below). Therefore, their connecting rod and connecting cylinder can be made of ordinary steel.

D) Water-Proofing for Insulating Blocks at the House Frame

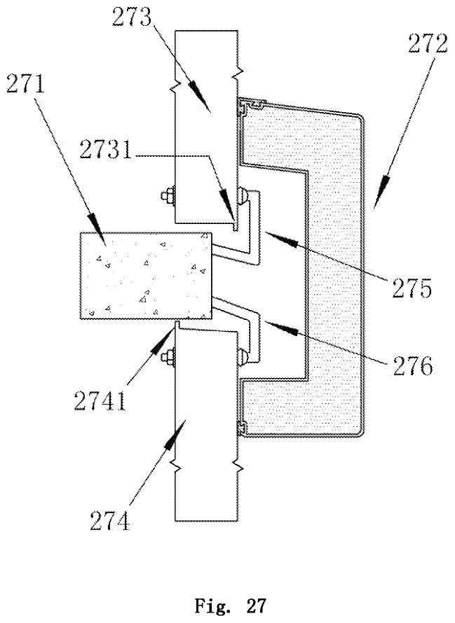

Water-proofing Of Horizontal Insulating Blocks: As shown in the side view of FIG. 27, the horizontal insulating block 272 is installed outside of the horizontal part 271 of house frame; The external wall's multiple-layered insulating blocks 273, 274 respectively above and below the horizontal part 271 of house frame are pushed from inside the room onto connecting rods 275,276, and are fixed by the gasket and bolt nut at their end (see details in paragraphs 0153,0154 of the Description of original patent). When the rain flows along multiple-layered insulating block 273, a part of it will enter the tiny rift between insulating blocks 272,273. To prevent the rain from dropping onto the horizontal part 271 of house frame and then enter the room, a protruding brim 2731 shall be set at the bottom of insulating block 273's outer side (and/or the bottom of insulating block 273 shall be set slant outward), and the outer side of insulating block 273 shall surpass the position of horizontal part 271 of house frame, thus the rain will be unable to flow from insulating block 273's outer side onto the horizontal part 271 of house frame. At the same time, on the top of the inner side of insulating block 274 there shall be set an protruding brim 2741 (and/or the top of insulating block 274 shall be set slant outward), and the position of insulating block 274 shall surpass that of the horizontal part 271 of house frame, so as to be aligned with the position of insulating block 273. By this means, the rain will flow from the outer side of block 273 onto the outer side of block 274, but not enter the room. Besides, the sealing elastic rubber bar installed in the groove at the lower brim of insulating block 272 shall have two segments or more and the gap for drainage of rain shall be set therein; At the upper brim of insulating block 272 there might be set two grooves to make the elastic rubber bent outward, so a better drainage of water can be done. The connecting rods of insulating blocks 273,274 and the connecting bars of insulating block 272 shall be staggered and fixed in the horizontal part 271 of house frame. On the outer side of insulating blocks 273,274 there shall be set grooves around connecting rods 275,276, so as to prevent the rain from flowing into the insulating blocks.

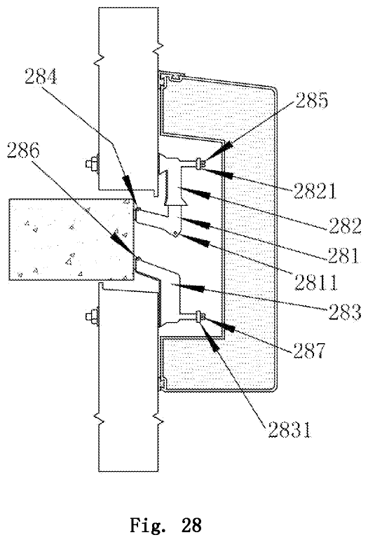

The connecting rods 275,276 of the external wall's insulating blocks 273,274 and the connecting rods of the horizontal insulating block 272 need to be made of materials not easy to rust or corrode such as stainless steel. Otherwise, rain covers must be set on them. The rain covers for connecting rods of horizontal insulating block 272 may be set as what's described in part C above and in FIG. 26. The rain covers for the upper connecting rod 275 and lower connecting rod 276 of the external wall's insulating blocks 273,274 may be set as per the side view of FIG. 28: On the upper connecting rod there is installed the middle rain cover 281 and the upper rain cover 282; On the lower connecting rod there is installed the lower rain cover 283. At the lower part of the upper connecting rod there is set hole 284 or more holes; In rain cover 281 there are set holes at the position of hole 284. The lower part of rain cover 281 surpasses the bottom of the bending part of the upper connecting rod, and has holes 2811 at its two sides at the level lower than the bottom of the bending part of the upper connecting rod. During installation, rain cover 281 shall be put at the lower part of the upper connecting rod, and be fixed by binding strip etc. put through hole 284 or more holes. The upper connecting rod shall be extended to the right, and a hole 285 shall be set at its end; The upper rain cover 282 shall envelope the upper connecting rod's extended part to the right and have holes at the position of hole 285, have protuberance 2821 at the left side of hole 285; The protuberance 2821 can prevent the rain form flowing to the right end. During installation rain cover 282 shall be pushed in the right-to-left direction so that it is pushed to the upper part of the upper connecting rod. Then fix the upper rain cover 282 with binding strip etc. put through hole 285. The notch at the right side of hole 285 can fix the position of binding strip so as to prevent the rain cover from being loose. At the lower part of rain cover 282 it shall bend outward to cover the top of rain cover 281; At the left brim of rain cover 282 it shall also bend outward to prevent the rain form flowing to the inner side of rain cover 282. At the lower connecting rod there is set hole 286 or more holes; And in the lower rain cover 283 there are set holes at the position of the lower connecting rod's hole. The lower part of the lower connecting rod shall be extended to the right, and a hole 287 shall be set at its end. Also on rain cover 283 a protuberance 2831 is set at the left side of hole 287; The protuberance 2831 can prevent the rain form flowing to the right end. During installation rain cover 283 shall be pushed in the right-to-left direction so that it is pushed to the lower connecting rod and clamp it. Then fix the lower rain cover 283 with binding strip etc. put through holes 287,286. The notch at the right side of hole 287 can fix the position of binding strip so as to prevent the rain cover from being loose. At the lower brim of rain cover 283's upper part and at the left brim of its lower part it shall bend outward to prevent the rain form flowing to the inner side of rain cover 283.

Alternatively, of the middle rain cover 281, upper rain cover 282, and lower rain cover 283, one or more may be fixed to the connecting rod through one or more of the following means: buckling, sticking, welding, embedding, riveting, and bolting.

For water-proofing of insulating blocks at the house frame, there is another way below which is better for insulation:

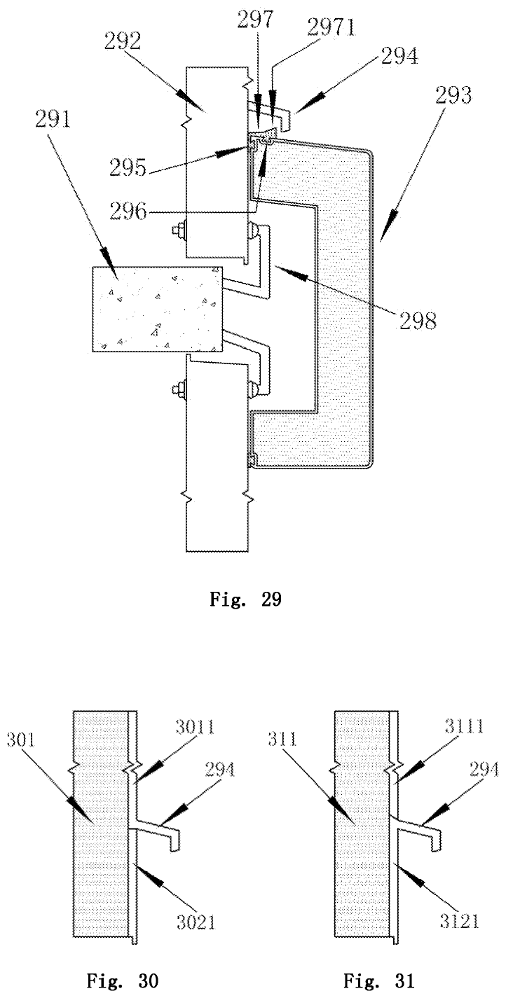

As shown in the side view of FIG. 29, on the external wall's multiple-layered insulating block 292 above the horizontal part 291 of house frame there is set rain board 294 along the horizontal insulating block 293 through one or more of the following means: direct-molding, melting-connection, bending, sticking, etc., so that the rain will not flow into the tiny rift between the horizontal insulating block 293 and the external wall's insulating block 292. In this way, the connecting rods of insulating block 292 and those of insulating block 293 can be made of ordinary steel and no rain covers need to be set on them. But the rain board 294 must be firmly installed on the outer side of the multiple-layered insulating block 292. At the same time, on the top of insulating block 293 and near its brim there need to be set double grooves 295,296, in which grooves there shall be set elastic rubber bar 297 or other elastic materials; On the top of elastic rubber bar 297 there shall be set a protuberance 2971; The level of protuberance 2971 shall be higher than the lower brim of rain board 294. During installation, firstly mount insulating block 293, then insulating block 292. As insulating block 292 is being pushed outwards along connecting rod 298, rain board 294 will touch protuberance 2971 then press down protuberance 2971 and pass it to let it restore the original shape. As protuberance 2971 is higher than the lower brim of rain board 294, the rain cannot pass protuberance 2971 to reach the inner side of insulating block 293.

When installing the rain board on the external wall's multiple-layered insulating block along the horizontal insulating block, if the method of bending is used, it can be done as per the side view in FIGS. 30,31. In FIG. 30, the outer layer 3011 of the external wall's multiple-layered insulating block 301 above the horizontal part of house frame is bent outward to form rain board 294 at the level a little above the horizontal insulating block. At the outer layer of insulating block 301 there is installed the lower outer panel 3021 below rain board 294. Outer panel 3021 extends to the bottom of insulating block 301. This method may be called Upper Bending.

In FIG. 31, the outer layer of the external wall's multiple-layered insulating block 311 above the horizontal part of house frame is cut at the level a little above the horizontal insulating block to form the upper outer panel 3111; The cutting face shall slant outward. At the outer layer of insulating block 311 there is installed the lower outer panel 3121. Outer panel 3121's top fits the slant cutting face and is bent outward to form rain board 294. Outer panel 3121 extends to the bottom of insulating block 311. This method may be called Lower Bending.

Between two neighboring left-and-right horizontal insulating blocks water-proofing also needs to be done, the method of which shall be the same as that for two neighboring left-and-right multiple-layered insulating blocks described in part 2A of Content Of Invention.

Water-proofing Of Vertical Insulating Blocks: As shown in the top view of FIGS. 24,25, the vertical insulating blocks 241,251 are respectively installed outside of the vertical parts 242,252 of house frame. Next, multiple-layered insulating blocks 244,245 at the two sides of the vertical part 242 of house frame and multiple-layered insulating block 254,255 at the two sides of the vertical part 252 of house frame are pushed onto the connecting rods from inside the room to complete the installation. Bent water boards 2441,2451 are respectively set at the side of insulating blocks 244,245; And bent water board 2541,2551 are respectively set at the side of insulating blocks 254,255. Therefore, when the rain flows along multiple-layered insulating blocks 244,245,254,255, it cannot pass rain boards 2441,2451,2541,2551 to enter the room.

Between two neighboring up-and-down vertical insulating blocks water-proofing also needs to be done, the method of which shall be the same as that for two neighboring up-and-down multiple-layered insulating blocks described in part 2A of Content Of Invention.

E) Water-Proofing for Protruding Column on Roof

When the multiple-layered insulating blocks are installed on the roof, if there are protruding columns such as decorative chimneys, water-proofing may be done for them as follows:

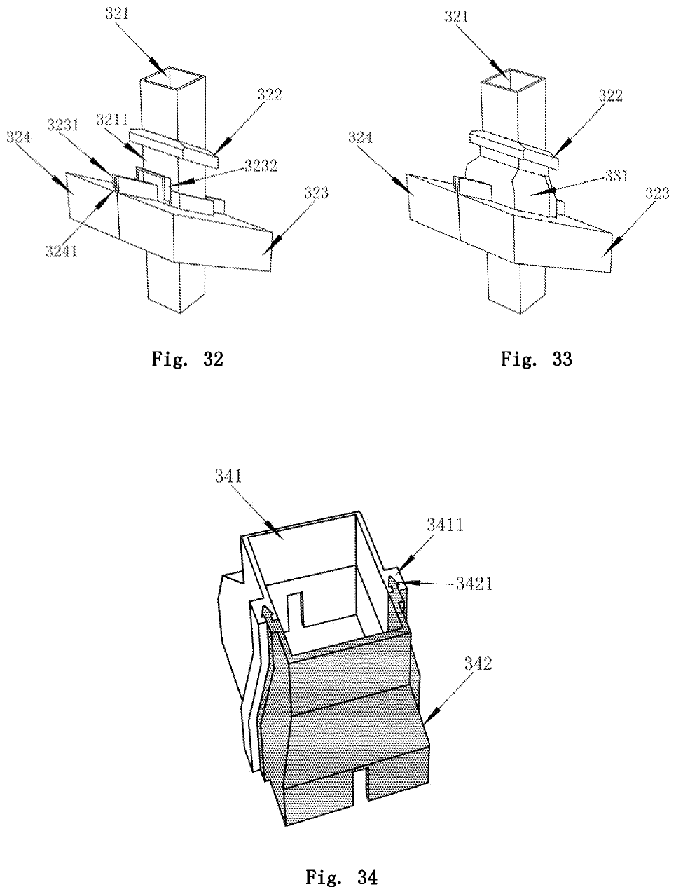

As shown in FIGS. 32,33,34, around protruding column 321 is set rain board 322; And the roofs outer insulating block 323, inner insulating block 324 have an opening for protruding column 321 (see FIG. 32). Insulating blocks 323,324 bend upward at their border, and also bend upward around the opening for the protruding column. Moreover, at the border of insulating blocks 323,324, the upward bending 3231 of the outer insulating block 323 covers the upward bending 3241 of the inner insulating block 324. Besides, the upward bending of insulating block 323 extends upward along the upper side 3211 of protruding column 321 to form the extended plate 3232. Extended plate 3232 is integrated to the upward bending 3231 to form one body which passes over the upward bending 3241, and on the side of the inner insulating block 324 this integrated body is at the upper side of the upward bending at the opening. The perimeter of extended plate 3232 bends upward, which can further prevent the rain flowing on the upward bending 3231 from entering the sift around the protruding column; The upward bending of extended plate 3232 shall not join insulating blocks 323,324, but have a space to make the rain easily drained.

Between protruding column 321's rain board 322 and the roofs insulating blocks 323,324 there is set the middle rain board 331 (see FIG. 33). Middle rain board 331 has the upper part 341 and the lower part 342 (see FIG. 34, which is enlarged for clarity). On the middle rain board's lower part 342 there may be set a protuberance 3421 which has an arrow-shaped section; On the upper part 341 there may be set the corresponding groove 3411. When the arrow-shaped protuberance 3421 is pushed into the groove 3411, the middle rain board's two parts 341,342 will be locked together. Alternative, these two parts may be connected through welding, sticking, binding, etc.

During installation, firstly join the outer insulating blocks 323 and the inner insulating block 324, then join the middle rain board's upper part 341 and lower part 342, and the rain will not be able to enter the space between the protruding column 321 and the insulating blocks 323,324, realizing a fine water-proofing.

3) Implementation of the Structure with Multiple Layers of Cavity

In the structure with multiple layers of cavity described before (in part 3 of Content Of Invention), the wooden insulating bars are mainly for assemblage of glass panels. If the wooden insulating bars are not of oily types, they may be stuck to the glass panels through structural adhesive. As long as the number of layers are not too many and the overall thickness is not too great, the multiple layers of glass panel connected by the structural adhesive and the bolts can be strong enough to avoid dislocation of the glass layers. If the structural adhesive is not good, or the wooden bars are of oily types, or the number of layers and the overall thickness are too great, then the multiple layers will have dislocation caused by gravity, shaking, etc. To avoid this problem, the triangle-shaped fastener described in paragraphs 0027,0028 of the original patent may be applied.

In the structure with multiple layers of cavity, the plastic insulating bars are mainly for assemblage of high polymer panels. They can also be used for assemblage of glass panels. If the structure with multiple layers of cavity of glass uses plastic insulating bars, then the fastener must be installed at its sides.

When fastener is used for the above structure with multiple layers of cavity and wooden insulating bars or plastic insulating bars, the triangle-shaped fastener described in the original patent may be further developed as follows:

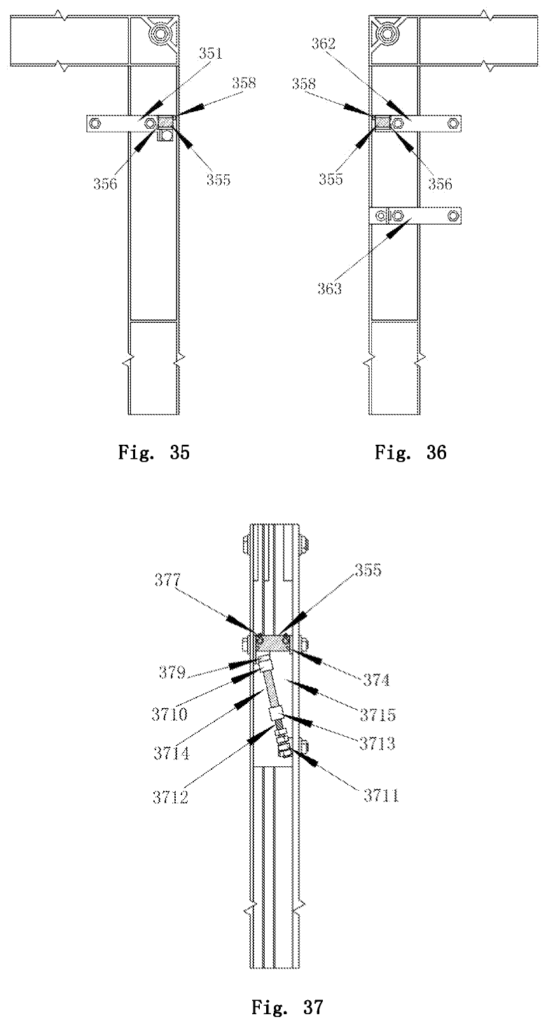

As shown in the front view of FIG. 35 and the back view of FIG. 36, on the front-most layer and back-most layer of the structure with multiple layers of cavity there are respectively connected the front fastening plate 351, and the upper back fastening plate 362, lower back fastening plate 363. On the inner side of fastening plates 351,362 there may be set the slant plates 374 (see the side view in FIG. 37, which is enlarged for clarity); And in wooden block 355 (or a block of other low-heat-conductivity materials) there are set slant grooves corresponding to the slant plates 374, so that the wooden block 355 can be pushed onto the slant plates 374 from the side. Fastening plates 351,362 are connected by wooden block 355. When wooden block 355 is pushed onto the slant plates, its front side touches the bent sides 356 of fastening plates 351,362 (see the perspective view of FIGS. 35,36), and its back side is fixed by pin 377 (see the side vide in FIG. 37); Pin 377 passes through the pin hole 358 in the slant plates (see the perspective view of FIGS. 35,36). On the turning piece 379 of fastening plate 351 there is set a connector which may be a cylinder 3710 (see the side view in FIG. 37); In the turning piece 3711 of fastening plate 363 there is set a hole through which there is set threaded rod 3712; On threaded rod 3712 there is set a connector which may be a cylinder 3713. The two ends of wooden connecting bar 3714 (or a connecting bar of other low-heat-conductivity materials) are respectively connected to the connectors of turning piece 379 and threaded rod 3712. On threaded rod 3712 there are set nuts at the two sides of turning piece 3711's hole; Through turning these nuts, the distance between turning pieces 379,3711 can be adjusted, so as to avoid dislocation of the front-most layer and the back-most layer. At the same time, a rabbet 3715 shall be made on each of the middle layers of the multiple-layered insulating structure, and wooden block 355 is put in this rabbet, the top of wooden block 355 pushed onto the top of rabbet at each middle layer; Thus sinking and dislocation of each middle layer are prevented.

The above fastener can effectively avoid the thermal bridge of the fastener in the original patent, further improving the insulating performance of the structure with multiple layers of cavity.

4) Implementation of Insulating Structures of Thin Film

A) In the multiple-layered connection described before (in part 4A of Content Of Invention), if the number of threaded rods at the inner side of external wall or at the bottom of the ceiling are not many, the area of each layer's cavity may be too big and affect the insulation. To avoid this, between two parallel separating straps there may be set a number of traverse straps, and between the traverse straps there may be further set straps. By this means, when two parallel separating straps are installed onto the cross-shaped connectors, the straps between them are also installed, separating the cavity into more.

In the above multiple-layered connection, the cross-shaped connector may be replaced by triangle-shaped or star-shaped connectors, so as to reduce or increase the number of its terminals for connection. The positions of threaded rods may form the shapes of grid, rhombus, honeycomb, etc. The straps between the parallel separating straps may also form various shapes.

B) In the block connection described before (in part 4B of Content Of Invention), the front side of all the insulating structures of thin film shall have a shape of square, or rhombus, or any other shape that can be consecutively connected; The back side of them shall have double-sided adhesive tape etc. so that they can be conveniently stuck to the inner side of external wall, the bottom of ceiling, and the inner side of door and/or window (The methods of suspension, buckling, etc. may also be used. Which method to use shall depend on the weight of the insulating structure of thin film, and the specific structure and materials of the inner side of the house. For example, if the house has brick walls, its inner side is smooth, and the weight of the insulating structure of thin film is light, then the method of sticking shall be suitable; If the house is made of wood, its inner side is not smooth, and the weight of the insulating structure of thin film is relatively heavy, then the method of suspension may be suitable). The insulating structures of thin film may also be stuck or put on the floor where people need not to go. Their lateral sides may also have double-sided tape or buckles etc. to make them connected to each other. For example, at the external wall of a wooden house, there may be suspended a row of insulating structures of thin film only at the top, and the rest of the insulating structures can be connected to each other. On the floor where people need to go, high-strength foam panels of polystyrene may be put with a layer of wear-resisting vinyl set on their top for protection, other insulating mat may also be put.

When on the six sides of a room there are installed insulating structures of thin film or put insulating mat, the heat transfer coefficients of them at each part of the room shall match, and great difference of heat transfer coefficient must be avoided, so as not to lower the thermal insulation effect, and not to waste the materials.

C) When the insulating structures of thin film are produced by the method of extrusion-molding or web-shaped addition described before (in parts 4Ba,4Bb\textcircled{4} of Content Of Invention, and FIGS. 12,17,18), each insulating structure has two sides of triangle-shaped section. When these sides overlap at the boarder of two insulating structures, the insulating structures will slant. Although this can bring a special visual effect, they occupy more space inside the room in comparison to the thin-filmed insulating structures produced in other methods. Therefore, they are suitable to be installed in rooms with abundant space.

If the multiple-layered structure of thin film described before (in part 4Ba of Content Of Invention, and FIG. 12) is directly molded by melted plastic through injection-molding, then this multiple-layered structure can not only have the top layer 122, bottom layer 123, left side 124, right side 125, and middle layers 126,127,128, etc.—but also have a front side or back side molded together with them. And after the molding only one side at the back or front is not made. This last missing side can be added by welding manually or automatically.

With this multiple-layered structure by injection-molding, the thickness of film cannot reach conventional values. So its cost will be increased. But in buildings that do not need conventional thin-film it can be used.

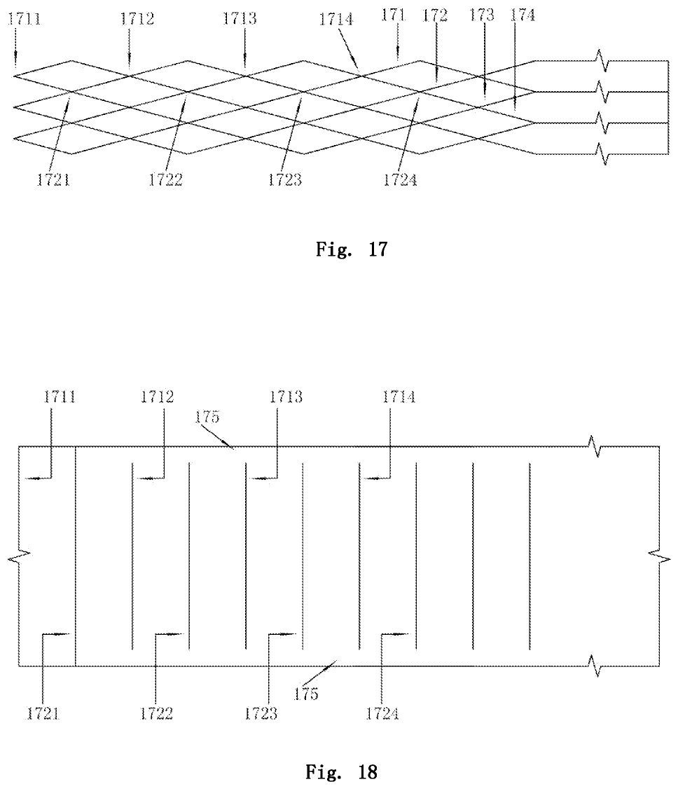

The insulating structure of thin film produced by web-shaped addition with cylinder-shaped thin film described before (in part 4Bb\textcircled{4} of Content Of Invention, and FIGS. 17,18) needs to have a sealable air-inflating hole set at each layer of cavities, because between its upper layer of cavities and lower layer of cavities there is no sealing, and the cavities will be deflated if there is a hole to penetrate every layer. However, the insulating structure of thin film produced by web-shaped addition with double films has the double films welded along a line connecting the ends of the connection lines 1711,1712,1713,1714, etc., thus sealing is done between its upper layer of cavities and lower layer of cavities, and a hole penetrating every layer of cavities can avoid leakage of air. Therefore, only one sealable air-inflating hole needs to be set for each insulating structure.

D) The insulating structures of thin film produced by the methods of sticking or welding, and by the method of direct molding such as extrusion-molding, which are described before (see part 4 of Content Of Invention), can all be used independently. Moreover, with the methods of straight brim addition and flat brim addition, special shapes can be made by the moulds through blow-molding or suck-molding. The various insulating structures of thin film can have different shapes and/or colors, patterns, with different lights to create rich and colorful visual effects.

The above insulating structures of thin film produced by the methods of sticking or welding, and by the method of direct molding such as extrusion-molding—can be put into coats of their corresponding shapes as core. Among them the insulating structures of thin film produced by the method of direct molding and by the method of web-shaped addition with single thin film, which have sides of triangle-shaped section, and the insulating structures of thin film produced by the method of web-shaped addition with cylinder-shaped thin film, which have some unsealed cavities, will avoid their disadvantage and make use of their simplicity when they are put into covers. At the same time, the covers can be conveniently made with different decorative shapes to match the various types of room.

5) Application and Wide Use of the Highly Insulated House

The double-wythed external wall described before (in part 1B of Concrete Implementation Methods) has insulating fiber put between the double wythes and has the thermal-break bridge installed to reach any insulating level needed in reality. It can be put to permanent use, but the cost is higher than single-wythed external wall. It may be applied mostly on luxurious buildings.

The thermal-break bridge described before (in part 1 of Content Of Invention) may be applied on insulated doors and/or windows of brick houses and curtain-wall houses. It can help them reach any insulating level needed in reality and can be put to permanent use.

The ways to realize water-proofing and air-sealing between blocks of insulating wall and roof, which are described before (in part 2 of Content Of Invention), may be applied on buildings of curtain-wall of various materials. These buildings of curtain-wall can reach high level of energy-saving (reach any insulating level needed in reality) and realized prefabricated construction (see details in paragraphs 0152˜0165 of the original patent's Description), greatly simplifying the procedures of construction, improving the efficiency, and lowering the cost. Also, the multiple-layered insulating structure of the curtain wall can be used for insulating renovation of houses already built (see paragraphs 0166, 0167 of the original patent's Description).

The ways to assemble the structure with multiple layers of cavity, which are described before (in part 3 of Content Of Invention), can further improve the door and/or window's thermal insulation. Moreover, these door and/or window of multiple-layered insulating structure can have the anti-burglary function through increasing the strength of their outer layer. And their visual effects may be freely realized through setting covers for them.

The various insulating structures of thin film described before (in part 4 of Content Of Invention) have light weight and low cost; And except for the type by multiple-layered connection, other types of these insulating structures can be conveniently installed and taken down. They play an indispensible role in the wide use of the highly insulated house: In every type of houses that are already built, they can be installed at the inner side of external wall, at the bottom of ceiling, at the inner side of door and window, and on the floor where people do not need to go; When they have about 5 layers with an overall thickness of about 10 cm, and on the floor where people need to go there are put insulating panels of similar heat transfer coefficient, 90% or more of the energy for heating and cooling of the house can be saved (If a higher level of insulation than this is needed, the number of layers and overall thickness of these insulating structures shall be adjusted). When new houses of high insulation need to be built, to use these insulating structures of thin film is also one of the options.

In economically undeveloped areas, using the above insulating structures of thin film can solve the problems caused by severe cold or heat. In developed areas, these insulating structures of thin film can also save energy to a large extent and help sustainable development of the society. On the other hand, the above highly insulating double-wythes wall, multiple-layered insulating structure, etc. also have important roles to play, especially the multiple-layered insulating structure which can be made of glass or high polymer materials. When this multiple-layered insulating structure has about 4 layers with an overall thickness of about 10 cm, its insulation performance can even surpass that of 8.5 cm thick insulating fiber, and it can save 90% or more of the energy for heating and cooling of the house; This structure can have prefabricated construction which maintains the visual effects of glass curtain wall, attaining the double aims of high energy-saving and low cost, thus its construction shows the promise of becoming the main-stream in many areas. At the same time, this structure can be used for interior decoration to reach the same level of insulation and realize various visual effects through setting covers.

1. A highly insulated house, in which the insulating structure with multiple layers of cavity has a structure of insulating fibers that is set at the sides to prevent heat conductivity and to further boost the insulating performance of the whole house.

2. The highly insulated house according to claim 1, wherein the insulating structure with multiple layers of cavity has wooden insulating bars:
In one of the cavities of the insulating structure (91) with multiple layers of cavities, wooden horizontal insulating bar (92) and vertical insulating bar (93) are connected at the perimeter of the cavity at the position of bolt hole (94); In wooden insulating bars (92,93) there are set connectors (95); Connectors (95) join the connectors of plastic insulating bars (96); Multiple plastic insulating bars (96) are connected to the wooden insulating bars (92,93) to form successive small boxes (98); Small boxes (98) are filled with insulating fiber; Thus heat conductivity between sides of the multiple layers of cavity and the outside can be minimized.

3. The highly insulated house according to claim 1, wherein the insulating structure with multiple layers of cavity has plastic insulating bars:
In one of the cavities of the insulating structure (101) with multiple layers of cavities, plastic insulating bars (102) form successive horizontal boxes, plastic insulating bars (103) form successive vertical boxes; In the perimeter of the cavity at the position of bolt hole (104) the horizontal boxes and vertical boxes are connected; At the position of bolt hole (104) the horizontal box of insulating bar (102) and the vertical box of insulating bar (103) have a ring with spokes connecting the ring to the horizontal or vertical box; The horizontal and vertical boxes are filled with insulating fibers (105), so that the heat conductivity between sides of the multiple layers of cavity and the outside can be minimized.

4. The highly insulated house according to claim 1, wherein the insulating structure with multiple layers of cavity has fastener with thermal-break bridge:
On the front-most layer and back-most layer of the structure with multiple layers of cavity there are respectively connected the front fastening plate (351), and the upper back fastening plate (362), lower back fastening plate (363); Fastening plates (351,362) are connected by wooden block (355); On the turning piece (379) of fastening plate (351) there is set a connector; In the turning piece (3711) of fastening plate (363) there is set a hole through which there is set threaded rod (3712); On threaded rod (3712) there is set a connector; The two ends of wooden connecting bar (3714) are respectively connected to the connectors of turning piece (379) and threaded rod (3712); On threaded rod (3712) there are set nuts at the two sides of turning piece (3711)'s hole; Through turning these nuts, the distance between turning pieces (379,3711) can be adjusted, so as to avoid dislocation of the front-most layer and the back-most layer.
The above fastener forms the thermal-break bridge, further improving the insulating performance of the structure with multiple layers of cavity.

5. The highly insulated house according to claim 1, wherein insulating plate is set at the inner side of the multiple-layered insulating blocks of external wall and/or roof:
At the external wall and/or roof, the left multiple-layered insulating block (191) and the right multiple-layered insulating block (192) have connectors (195) at the inner side near their boundary; In insulating plate (216) there are set slots (2161); Spinous strip (227) has connector (2271) at its end; Connector (2271) can be connected to connector (195) so that spinous strip (227) is connected to multiple-layered insulating blocks (191,192); Spinous strip (227) can enter slot (2161); Slot (2161) can lock spinous strip (227), making it movable only to the outer direction so as to fasten insulating plate (216);
Spinous strip (227) may be separately set; It may also be set as an integrated part of the multiple-layered insulating block.

6. The highly insulated house according to claim 1, wherein rain boards are set for protruding columns at the roof:
Around protruding column (321) is set rain board (322); The roofs outer insulating block (323), inner insulating block (324) have an opening for protruding column (321); The insulating blocks (323,324) bend upward at their border, and also bend upward around the opening for the protruding column; At the border of insulating blocks (323,324), the upward bending (3231) of the outer insulating block (323) covers the upward bending (3241) of the inner insulating block (324); The upward bending of insulating block (323) extends upward along the upper side (3211) of protruding column (321) to form the extended plate (3232); Extended plate (3232) is integrated to the upward bending (3231) to form one body which passes over the upward bending (3241), and on the side of the inner insulating block (324) this integrated body is at the upper side of the upward bending at the opening; The perimeter of extended plate (3232) bends upward, which can further prevent the rain flowing on the upward bending (3231) from entering the sift around the protruding column; The upward bending of extended plate (3232) shall not join insulating blocks (323,324), but have a space to make the rain easily drained;
Between protruding column (321)'s rain board (322) and the roofs insulating blocks (323,324) there is set the middle rain board (331); Middle rain board (331) has the upper part (341) and the lower part (342), which are combined together.

7. A horizontal insulating block at the frame of insulated house:
Said horizontal insulating block (231) is connected to connecting bar (233) and connecting cylinder (234); Connecting cylinder (234) is set around connecting bar (233); The insulating block (231)'s connecting bar (233) is inserted into the connecting cylinder (235) of the house frame's connecting rod (237); Connecting cylinder (235) of the house frame's connecting rod (237) is inserted into connecting cylinder (234) of the insulating block; Connecting bar (233) of the insulating block passes through connecting cylinder (235) of the house frame's connecting rod (237), and has screw thread and bolt nut (236) or a pin at its end; Thus the insulating block's connecting bar (233) and connecting cylinder (234) are fixed to the connecting cylinder (235) of the house frame's connecting rod (237); The house frame's connecting rod (237) is connected to the horizontal part (238) of the house frame.

8. A Structure for water-proofing of horizontal insulating blocks at the frame of insulated house:
The horizontal insulating block (272) is installed outside of the horizontal part (271) of house frame; The external wall's multiple-layered insulating blocks (273, 274) respectively above and below the horizontal part (271) of house frame are pushed from inside the room onto connecting rods (275,276), and are fixed by the gasket and bolt nut at their end; A protruding brim (2731) is set at the bottom of insulating block (273)'s outer side, and/or the bottom of insulating block (273) is set slant outward; and the outer side of insulating block (273) surpasses the position of horizontal part (271) of house frame; thus the rain is unable to flow from insulating block (273)'s outer side onto the horizontal part (271) of house frame; On the top of the inner side of insulating block (274) there is set an protruding brim (2741), and/or the top of insulating block (274) is set slant outward; and the position of insulating block (274) surpasses that of the horizontal part (271) of house frame, so as to be aligned with the position of insulating block 273; so the rain will flow from the outer side of block (273) onto the outer side of block (274), but not enter the room;
Alternatively, the structure for water-proofing may be as follows:
On the external wall's multiple-layered insulating block (292) above the horizontal part (291) of house frame there is set rain board (294) along the horizontal insulating block (293), so that the rain will not flow into the tiny rift between the horizontal insulating block (293) and the external wall's insulating block (292); On the top of insulating block (293) and near its brim there are set double grooves (295,296), in which grooves there is set elastic rubber bar (297); On the top of elastic rubber bar (297) there is set a protuberance (2971); The level of protuberance (2971) is higher than the lower brim of rain board (294); Insulating block (292) is pushed outwards along connecting rod (298), and rain board (294) presses down protuberance (2971) and passes it to let it restore the original shape; As protuberance (2971) is higher than the lower brim of rain board (294), the rain cannot pass protuberance (2971) to reach the inner side of insulating block (293);
For connection of the rain board on the external wall's multiple-layered insulating block along the horizontal insulating block (293), the method of Upper Bending or Lower Bending is used; In the Upper Bending, the outer layer (3011) of the external wall's multiple-layered insulating block (301) above the horizontal part of house frame is bent outward to form rain board (294) at the level a little above the horizontal insulating block; At the outer layer of insulating block (301) there is installed the lower outer panel (3021) below rain board (294); Outer panel (3021) extends to the bottom of insulating block (301);
In the Lower Bending, the outer layer of the external wall's multiple-layered insulating block (311) above the horizontal part of house frame is cut at the level a little above the horizontal insulating block to form the upper outer panel (3111); The cutting face shall slant outward; At the outer layer of insulating block (311) there is installed the lower outer panel (3121); Outer panel (3121)'s top fits the slant cutting face and is bent outward to form rain board (294); Outer panel (3121) extends to the bottom of insulating block (311).

9. The structure for water-proofing according to claim 8, wherein the upper connecting rod (275) and the lower connecting rod (276) of the external wall's multiple-layered insulating blocks (273, 274) have rain covers as follows:
On the upper connecting rod there is installed the middle rain cover (281) and the upper rain cover (282); On the lower connecting rod there is installed the lower rain cover (283); At the lower part of the upper connecting rod there is set hole (284) or more holes; In rain cover (281) there are set holes at the position of hole (284); Rain cover (281) is put at the lower part of the upper connecting rod, and is fixed by binding strip put through hole (284) or more holes; The upper connecting rod is extended to the right, and a hole (285) is set at its end; The upper rain cover (282) envelopes the upper connecting rod's extended part to the right and have holes at the position of hole (285), have protuberance (2821) at the left side of hole (285); Rain cover (282) is pushed to the upper part of the upper connecting rod and is fixed with binding strip put through hole (285); At the lower connecting rod there is set hole (286) or more holes; And in the lower rain cover (283) there are set holes at the position of the lower connecting rod's hole; The lower part of the lower connecting rod is extended to the right, and a hole (287) is set at its end; Also on rain cover (283) a protuberance (2831) is set at the left side of hole (287); Rain cover (283) is pushed to the lower connecting rod to clamp it, and is fixed with binding strip put through holes (287,286);
Alternatively, of the middle rain cover (281), upper rain cover (282), and lower rain cover (283), one or more may be fixed to the connecting rod through one or more of the following means:
buckling, sticking, welding, embedding, riveting, and bolting.

10. A vertical insulating block at the frame of insulated house:
Except for the position at the corner of house, the vertical insulating block (241) is mounted to the vertical part (242) of the house frame; The method to connect the vertical insulating block (241) to the house frame's connecting rod (243) is the same as what's described in claim 7 about connection of the horizontal insulating block (231) and the house frame's connecting rod (237): On vertical insulating block (241) there are set connecting cylinder and connecting bar; On the house frame's connecting rod (243) there is set connecting cylinder; These connecting cylinders are inserted or pushed to each other; And the vertical insulating block's connecting bar passes through the house frame's connecting cylinder, having screw thread and bolt nut or a pin at its end;
At position of the corner of house, the vertical insulating block (251) is connected to the vertical part (252) of the house frame; If the angle of house corner is ninety degrees, the connecting cylinder of the house frame's connecting rod (253) shall have an angle of forty five degrees to the wall of house, and insulating block (251)'s connecting bar and connecting cylinder shall also have an angle of forty five degrees to the wall, so that these connecting bar and connecting cylinders are in the same direction; If the angle of house corner is not ninety degrees, direction of the connecting cylinder of the house frame's connecting rod (253), and of insulating block (251)'s connecting bar and connecting cylinder shall be adjusted accordingly, so that they are kept in the same direction; Insulating block (251)'s connecting bar is pushed into the connecting cylinder of the house frame's connecting rod (253), which connecting bar has screw thread and bolt nut or a pin at its end to fix it; Also, the connecting cylinder of house frame's connecting rod (253) is inserted to the insulating block (251)'s connecting cylinder; Thus insulating block (251) is firmly fixed to connecting rod (253).

11. An insulating structure of thin film for insulation of buildings, which has one or more of the following connection methods:
Multiple-layered connection, block-connection by manual sticking or welding, block-connection by direct molding, block-connection by flat brim addition, block-connection by straight brim addition, and block-connection by web-shaped addition.

12. The insulating structure of thin film according to claim 11, wherein the multiple-layered connection is used:
Threaded rod (111) is installed in the inner side of external wall and/or in the bottom of ceiling; Cross-shaped connector (112) has a circular hole (113) at its center, and has connectors (114) at its four terminals for connection of thin film separating straps; In circular hole (113) there is set disk (115) that is made of insulating materials, and that has a hole in the center to match threaded rod (111) and let threaded rod (111) enter the hole;
In the first layer of large thin films for the inner side of external wall and/or the bottom of ceiling, holes are made in the positions of threaded rods (111); These thin films are put onto the threaded rods (111), and disks (115) is pressed onto the threaded rods (111); The neighboring large thin films are stuck together with adhesive tape; The circular holes (113) of connectors (112) are put onto disks (115); The thin film separating straps are connected by the connectors (114) between every two neighboring threaded rods (111);
This insulating structure of thin film has multiple layers; Installations of the large thin films, disks, cross-shaped connectors, and thin film separating straps in the second layer and every other layer are the same as in the first layer; On the top layer gaskets of plastic are put onto the end of threaded rods (111); The diameter of these gaskets is greater than circular hole (113); A nut is installed onto the threaded rod (111), and an insulating cap is put onto the nut.
With this multiple-layered connection, the cross-shaped connector may be replaced by triangle-shaped or star-shaped connectors, so as to reduce or increase the number of its terminals for connection.

13. The insulating structure of thin film according to claim 11, wherein the block-connection by direct molding is used:
Multiple-layered structure (121) of thin film is directly molded, and has the top layer (122), bottom layer (123), left side (124), right side (125), and multiple middle layers 126,127,128; It is cut to sections and each section is welded along the cutting lines; For each section, a hole is made on the top layer (122) by puncturing, which hole penetrates the middle layers (126,127,128), but does not penetrate the bottom layer (123); A sealable air-inflating hole is set on top layer (122) at where the punctured hole is.

14. The insulating structure of thin film according to claim 11, wherein the block-connection by manual sticking or welding is used:
A support is put to stretch a section of cylinder-shaped thin film to be a frame (131); Inside frame (131), the two sides (1321,1322) of multiple thin films (132) which have the same width as this frame are respectively welded or glued to the two sides (133,134) of frame (131); This welding or gluing is done at thin film (132)'s end points and a number of middle points along the line where it is connected to the sides of frame (131); In the longitudinal direction, frame (131) is longer than thin film (132); Two other thin films at the two empty sides of frame (131) are respectively welded to the brim where this frame is longer than thin film (132), by continuous welding without leaving a gap; Thus frame (131) becomes a multiple-layered insulating structure of thin film with its six sides sealed; At its surface layer there is made a hole by puncturing, and a sealable air-inflating hole is set at where the punctured hole is.

15. The insulating structure of thin film according to claim 11, wherein the block-connection by flat brim addition is used:
Box (141) of thin film is made in mould; It has convex brims (142) at its top and bottom, and an air-pipe (143) at its side; Box (144) is made in the same way as box (143), having convex brims (145) at its top and bottom, and an air-pipe (146) at its side; The two neighboring convex brims (142,145) are welded together to join the two thin film boxes (141,144) to one body. Multiple boxes of thin film are welded together to form the multiple-layered insulating structure of thin film.

16. The insulating structure of thin film according to claim 11, wherein the block-connection by straight brim addition is used:
Semi-box (151) of thin film is made in mould; It has convex brims (152) and opposite sides (153); A same mould is used to make another semi-box (154) of thin film which has convex brims (155) and opposite sides (156); The sides (153,156) of semi-boxes (151,154) are welded together to form a sealed box (167) that is full of air inside and has convex brims (152,155) respectively at its top and bottom; Sealed box (168) is made in the same way as sealed box (167), having convex brims (169) at its top and bottom; The two neighboring convex brims (155,169) are welded together to join the two sealed boxes (167,168) as one body; Multiple sealed boxes are welded together to form a multiple-layered insulating structure of thin film; At its top layer there is made a hole by puncturing, which hole penetrates all layers except the bottom layer; And a sealable air-inflating hole is set on the top layer at where the punctured hole is.

17. The insulating structure of thin film according to claim 11, wherein the block-connection by web-shaped addition is used, which has one or more of the following structures—structure with triangle-shaped section, structure with flat side, and structure of cylinder-shaped thin film:
In the structure with triangle-shaped section, multiple layers (171,172,173,174) of thin film are welded or glued together along the crosswise connection lines (1711,1712,1713,1714; 1721,1722,1723,1724); On each layer of thin film in the direction perpendicular to the connection lines a side 175 is set apart; Sides 175 is also welded or glued together along their outer brim, and its welding line or gluing line joins the outer-most connection lines (1711,1721), so that the sealing is done; A hole is made by puncturing at the top layer, which hole shall penetrate all layers except the bottom layer; And a sealable air-inflating hole is set on the top layer at where the punctured hole is; When inflation is done, the multiple thin film layers 171,172, 173, 174, are separated by air, and the multiple sides 175 which are joined together form a side with a triangle-shaped section;
In the structure with flat side, each of the multiple layers (171,172,173,174) of thin film has double films except the top layer and bottom layer; All the layers are welded or glued together along the connection lines (1711,1712,1713,1714); The sides 175 are joined in couples; By this means, when inflation is done sides (175) form a relatively flat side;
In the structure of cylinder-shaped thin film, the cylinder-shaped thin film is pressed flat to have double layers; Every layer of these thin films are welded along the crosswise connection lines (1711,1712,1713,1714), and the two crosswise connection lines at the ends of each layer shall be extended to be as long as the width of the thin film, so that these thin films are sealed, and sides (175) no longer need to be welded.

18. Overlapping rain boards for multiple-layered insulating blocks of insulated house:
At the external wall and/or roof, multiple-layered insulating blocks (21,22) are set at the upper stratum, multiple-layered insulating blocks (23,24) are set at the lower stratum; At the left and right side of each block rain boards (35,36) are respectively set, at the bottom of each block rain board (57) is set; Rain board (35) of block (22) is pushed to the inner side of rain board (36) of block (21); The rain boards at the two sides of each block in the upper stratum overlap; The rain boards at the left and right side of blocks (23,24) of the lower stratum as well as all the rest of blocks in the same stratum overlap in the same way as in the upper stratum; The top of or the rain board at the top of block (23) is pushed to the inner side of rain board (57) at the bottom of block (21), and the top of or the rain board at the top of all the rest of blocks at the same stratum as block (23,24) shall be pushed to the inner side of rain boards at the bottom of the blocks at the upper stratum; The lower part of rain board (36) of the upper stratum shall bend outward, so that it covers the top of rain board (36) of the lower stratum; Rain board (35) of the upper stratum shall not bend outward, but be aligned to rain board (35) of the lower stratum;
The rain board (57) at the bottom of every multiple-layered insulating block may be separately installed, or be an extension of the outer layer of the insulating block; In the latter case it may have one or more than one of the following three overlapping methods:
The lower part of the outer layer is bent outward so as to let the upper and lower insulating blocks overlap;
The lower part of each block is set wider than the upper part, so as to let the upper and lower insulating blocks overlap;
Each block is slanted in installation, so that the upper and lower insulating blocks overlap.

19. A connecting structure with thermal-break bridge function for insulated house:
At the position of outer frame of door and/or window, the outer frame (1) and external wall (2) are connected by connecting rod (3) and connecting blocks (4, 5) which are made of low heat conductivity materials; Connecting block (4) is firmly connected to the external wall through connector of the external wall/or the frame of house; Connecting block (4) is firmly connected to connecting rod (3) through bolt; And connecting block (5) is firmly connected to outer frame (1) of door and/or window through bolt;
An only route of heat conduction is formed between the external wall (2) and the outer frame (1) of door and/or window, which route of heat conduction is made of low heat conductivity materials; The length of this route is adjusted during the stage of design, so as to reach any needed thermal insulating level;
Besides being used for thermal-break bridge between external wall and outer frame of door and/or window, this connecting structure with thermal-break bridge function can also be used for external wall of double wythes plus an insulating layer in between, as the thermal-break bridge between the inner wythe of light materials and floor or ceiling.
